(19) United States
(12) Patent Application Publication
(10) Pub. No.: US 2002/0136863 A1
(43) Pub. Date: Sep. 26, 2002

(54) Silicon microlancet device and method of construction

(76) Inventors: Kumar Subramanian, Pleasanton, CA (US); Wilson Smart, Palo Alto, CA (US); Eugene Orloff, Berkeley, CA (US)

Correspondence Address: Wilson Smart, 245 Washington Avenue, Palo Alto, CA, 94301, US

(21) Appl. No.: 09/817,567

(22) Filed: Mar. 26, 2001

(51) Int. Cl. B32B 3/00

(52) U.S. Cl. 428/156; 428/195

(57) ABSTRACT

A minimally intrusive, self-use microlancet device is provided. The microlancet device is capable of piercing a patient's skin reliably and virtually painlessly for obtaining a blood sample. The microlancet device comprises a silicon wafer formed into a sharp probe for piercing the patient's skin. Also provided is a fabrication method for the microlancet device.

### TECHNICAL FIELD

This invention relates generally to microlancet devices and particularly to microlancet devices formed of silicon.

### BACKGROUND

Lancets are widely used in biodiagnostic applications to pierce a subject's skin to obtain a blood sample for measurement of blood constituents. Lancing with a conventional metal lancet frequently causes pain, and sometimes excessive bleeding. The smallest lancet or needle currently marketed for blood sampling has a diameter between 300 micrometers and 500 micrometers, and is constructed of stainless steel with beveled edges. Due to the large cross-section of these lancets, fingertip lancing is painful and frequent lancing causes calluses, impairment of the use of hands, and psychological trauma

Silicon microprobes for neurological research were described in Wise and Najafi, “Microfabrication techniques for integrated sensors and microsystems,” Science 254, pp. 1335-1342, 1991 These probes are sufficiently strong to penetrate brain tissue, but are too weak to penetrate skin because of the fabrication methods employed to make them.

Pisano and co-workers have developed several different methods of making silicon microneedles, as described in L. Lin, A. P. Pisano, and R. S. Muller, “Silicon processed microneedles,” 7th Int. Conf. Solid State Sensors and Actuators, Transducers '93, Yokohama, Japan (1993). Their needles are made of thin film silicon nitride and polysilicon, and have not been commercialized. Further, both Wise and Lin rely on boron doping to define the shape of the needle, which both significantly weakens the needle, and requires a lengthy and therefore expensive fabrication period.

In U.S. Pat. No. 6,187,210 B1, Lebouitz et al. describe an epidermal abrasion device. The device has a complex tip with an array of etched pyramids to abrade the skin. It is formed via complex wet etching steps and preferably uses thin SOI silicon wafers, both of which add to fabrication cost. The preferred embodiment of Lebouitz has a body approximately 300 micrometers wide and 150 micrometers thick. Because of its size and multifaceted tip structure, such a device is likely to cause greater tissue damage and thus pain if used as a lancet than the microlancet of the present invention.

It would be highly desirable to provide an improved silicon microlancet device which could reliably and virtually painlessly puncture skin and could be manufactured at low unit cost.

### SUMMARY

It is therefore an object of this invention to provide a microlancet device fabricated from a silicon substrate and method for the construction thereof. The shaft or probe of such a device is approximately the thickness of a human hair, much smaller than a conventional metal lancet, yet can penetrate skin reliably and virtually painlessly.

It is a further object of this invention to provide such a microlancet device which is fabricated from a silicon wafer. Silicon is compatible with integrated circuit (IC) fabrication and MEMS (microelectromechanical systems) technologies employing well established masking, deposition, etching, and high resolution photolithographic techniques. The present microlancet devices may be fabricated in mass quantities from silicon wafers through automatic IC and MEMS processing steps at minimal cost per device.

It is a further object of this invention to provide such a microlancet device which minimizes subject discomfort during lancing to obtain a blood sample. The dimensions of the lancet probe (length, width, and thickness) are very small and cause minimal tissue displacement and related lateral tissue pressure and nerve ending contact. In some cases the displacement may be so minimal that the subject feels no sensation at all during the process. For example in a clinical trial of 62 patients using a microlancet with a thickness of 100 micrometers, the majority found the insertion and retraction of the microlancet device in the arm to be painless. Of the total patients tested, 15% could not even feel the probe penetration and an additional 58% found the penetration to be barely noticeable. Such painlessness is especially important in the pediatric population and for subjects, such as diabetics who must test their blood several times a day.

It is a further object of this invention to provide such a microlancet device which minimizes mechanical failure (breakage) of the lancet during penetration and removal. Only minimal penetration effort is required due to the small lancet cross-section defined by the width and thickness dimensions. These dimensions are much smaller than those of conventional metal lancets. The small cross-section minimizes tissue damage, which is important in the geriatric population, where aging fragile skin can easily tear.

These devices retain the single crystal silicon structure of the starting wafer to preserve strength in the finished device and can use surface treatments to retard the formation of microcracks to maximize strength, flexibility, and fracture toughness. The strength of the microlancet can be further increased by optimal shaping. During fabrication, plasma etching is used to provide control of the probe shape with a smooth continuous profile without weak spots, thus both increasing strength and decreasing potential tissue damage and thus pain.

The microlancet can easily penetrate skin with a large safety factor relative to brittle fracture. Data from skin puncturing tests show that the average force required to puncture the skin (0.038 Newton) is minimal compared to the buckling force required to break the probe (0.134 Newton).

It is a further object of this invention to provide such a microlancet device which penetrates the subject's skin to obtain a blood sample of less that 1 microliter. The dimensions of the lancet probe (length, width, and thickness) are sufficiently small that a submicroliter blood volume is reliably obtained. The small volume produced is an especial benefit in the neonatal population where an infant's total blood volume is limited, and several samples may be required. In the general population, the small sample is useful in that it minimizes messiness.

Briefly, these and other objects of the present invention are accomplished by providing a microlancet device for penetrating the skin to obtain a blood sample. The device is fabricated from a silicon substrate and has a body portion and a probe portion for penetrating into the subject to access the bodily fluid.

### BRIEF DESCRIPTION OF THE DRAWINGS

Further objects and advantages of the present microlancet become apparent from the following detailed description and drawings (not drawn to scale) in which:

FIG. 1A is a sectional view illustrating a first step in a method of constructing a lancet device in accordance with the present invention with a silicon wafer being first cleaned by a sulfuric acid/hydrogen peroxide mixture in water;

FIG. 1B is a sectional view illustrating a second step in the method of constructing the lancet device in accordance with the present invention with approximately 2000 Angstrom nitride film being deposited on the wafer surface;

FIG. 1C is a sectional view illustrating a third step in the method of constructing the lancet device in accordance with the present invention with the nitride film being patterned using a coating of photoresist and exposed;

FIG. 1D is a sectional view illustrating a fourth step in the method of constructing the lancet device in accordance with the present invention with the nitride film being etched away leaving strips of uncovered bare silicon wafer;

FIG. 1E is a sectional view illustrating a fifth step in the method of constructing the lancet device in accordance with the present invention with the uncovered areas of silicon being etched away in bulk by potassium hydroxide (KOH) solution;

FIG. 1F is a sectional view illustrating the method of constructing the lancet device in accordance with the present invention with approximately 50 micrometers and approximately 100 micrometers being exposed after the fifth step;

FIG. 1G is a sectional view illustrating a sixth step in the method of constructing the lancet device in accordance with the present invention with a photoresist coat being applied to the silicon wafer;

FIG. 1H is a sectional view illustrating a seventh step in the method of constructing the lancet device in accordance with the present invention with the wafer being patterned and exposed and the lancet devices being “punched” out using a plasma etching process, and

FIG. 1I is a sectional view illustrating a final step in the method of constructing the lancet device in accordance with the present invention with the photoresist coating being removed resulting in a silicon lancet device with a nitride covered base.

FIG. 2 is a chart comparing the average pain perception values for the silicon microprobe device with those for a conventional metal lancet.

### DETAILED DESCRIPTION OF THE PREFERRED EMBODIMENTS

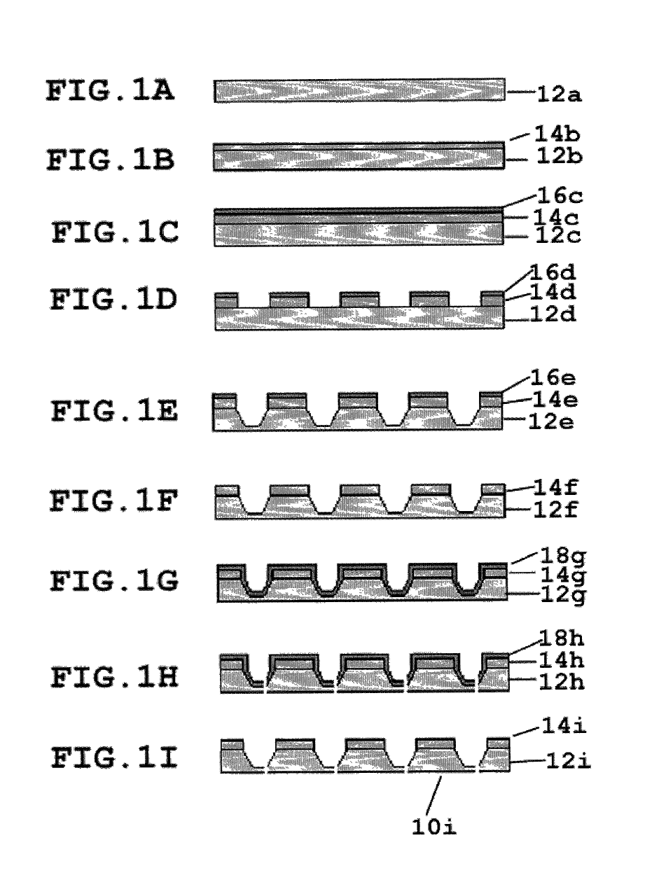

As illustrated in FIGS. 1A-1I, the present invention basically comprises a silicon lancet device, indicated generally at 10i, for piercing the subject's skin to obtain a blood sample for the measurement of biological materials therein. The lancet device 10i is fabricated from a silicon substrate.

Basically, the lancet device 10i is a very fine, short probe for piercing the skin of the patient to obtain a small blood sample. Preferably, the lancet device 10i is a silicon lancet having a cross-section between 50 micrometers and 250 micrometers at the base and tapering to a needle point. Furthermore, the lancet device 10i has a length between approximately 1 millimeter and 3 millimeters. The silicon lancet device that punctures the skin and produces a small, i.e. less than 1 microliter blood sample useful for diagnostic testing of the patient's blood. The lancet device 10i of the present invention is substantially painless and inhibits the formation of calluses on the patient's fingertips.

The steps of the fabrication process for constructing the lancet device 10i of the present invention are illustrated in FIGS. 1-9 and will now be described in detail. As illustrated in FIG. 1, to fabricate the silicon lancet device 10i of the present invention, first, a silicon wafer 12a is provided. The silicon wafer 12a is initially cleaned with cleaning mixture. Preferably, the cleaning mixture is a sulfuric acid/hydrogen peroxide mixture in water. As illustrated in FIG. 1B, a nitride film 14b having a thickness of approximately 2000 Angstroms is deposited on the surface of the silicon wafer 12b. Next, as illustrated in FIG. 1C, the nitride film 14c is patterned using a coating of photoresist 16c and exposed. Then, as illustrated in FIG. 1D, a portion of the nitride film 14d and the photoresist 16d is etched away leaving strips of uncovered bare silicon wafer 12d.

As illustrated in FIG. 1E, the uncovered areas of the silicon wafer 12e are etched away in bulk by potassium hydroxide (KOH). Etching the silicon wafer 12e with potassium hydroxide results in between approximately 50 micrometers and approximately 100 micrometers of the silicon wafer 12e being exposed, as illustrated in FIG. 1F. Next, as illustrated in FIG. 1G, a photoresist coating 18g is applied to the silicon wafer 12g. Then, as illustrated in FIG. 1H, the silicon wafer 12h is patterned and exposed and the lancet devices 10h are “punched” out using a plasma etching process. Plasma etching provides excellent control of the shape of the microlancet without forming weak spots. Finally, as illustrated in FIG. 1I, the photoresist coating 18h is removed resulting in a silicon lancet device with a nitride-covered base.

A large number of the present lancet devices 10i can be made at the same time on a single silicon wafer 12a, followed by dicing to separate the individual lancet devices 10i, each of which is commonly referred to as a die or chip in the microelectronics industry. Each lancet device is then sealed in an individual plastic package similar to that used to package integrated circuits.

### Pain Perception Testing

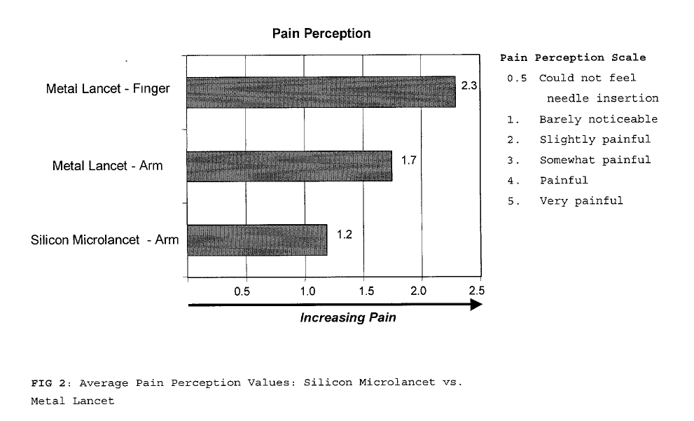

FIG. 2 shows the averaged response from 62 patients in a clinical trial to determine the relative pain perceived from punctures with a silicon microlancet in the arm compared with punctures in the arm and finger with conventional metal lancets. As can be seen from the FIG. 2, the punctures from the silicon microlancet were found to be noticeably less painful than those from the metal lancets, with the more painful of the two lancet tests being the finger stick, as expected. The test subjects repeatedly commented that the silicon microlancet puncture was virtually painless and far more comfortable than the finger stick with the metal lancet.

### Industrial Applicability

The silicon microlancet device 10i of the present invention accomplishes at least three distinct and novel advantages. First, the silicon lancet device 10i can be fabricated in high volume with tolerances much lower than prior art stainless steel lancets. Second, the silicon lancet device 10i has a much smaller diameter than the diameters of prior art lancets, which causes less pain and inhibits formation of calluses. Finally, the silicon lancet device 10i obtains a smaller blood sample from the patient, thereby only requiring a shallow puncture of the skin.

### Conclusion

Various changes may be made in the structure and embodiments shown herein without departing from the concept of the invention. For example, additional surface treatments may be utilized to improve the fracture toughness of the lancet device. Further, stress distribution calculations used to optimize probe shape may result in changes in etch methods. The particular embodiments were chosen and described in the same detail to best explain the principles of the invention and its practical application. Therefore, the scope of the invention is to be determined by the terminology of the following claims and the legal equivalents thereof.

We claim as our invention:

1. A microlancet device formed of silicon and having a sharp point for piercing the skin of a subject.

2. The microlancet device of claim 1 wherein the microlancet device has a cross section between approximately 50 micrometers and approximately 250 micrometers.

3. The microlancet device of claim 1 wherein the microlancet device has a length between approximately 1 millimeter and approximately 3 millimeters.

4. The microlancet device of claim 1 and further comprising a nitride film deposited on the silicon substrate.

5. The microlancet device of claim 5 wherein the nitride film has a thickness of approximately 2000 Angstroms.

6. The microlancet device of claim 5 and further comprising coating of photoresist on the nitride film.

7. The microlancet device of claim 5 and further comprising removing a portion of the nitride film.

8. The microlancet device of claim 8 wherein the portion of the nitride film is removed by potassium hydroxide.

9. The microlancet device of claim 9 and further comprising a photoresist coating applied to the silicon wafer.

10. The microlancet device of claim 10 and further comprising patterning the silicon wafer with a plasma etching process.

11. The microlancet device of claim 11 and further comprising removing the photoresist coating.

12. A method-of constructing a microlancet device formed of silicon and having a sharp point for piercing the skin of a subject, the method comprising:
providing a silicon substrate; and
plasma etching the silicon substrate into a sharp probe for piercing the patient's skin.

13. The method of claim 13 and further comprising etching the silicon wafer into a microlancet device having a diameter between approximately 50 micrometers and approximately 250 micrometers.

14. The method of claim 13 and further comprising etching the silicon wafer into a microlancet device having a length between approximately 1 millimeter and approximately 3 millimeters.

15. The method of claim 13 and further comprising applying a sulfuric acid/hydrogen peroxide mixture in water to the silicon wafer.

16. The method of claim 13 and further comprising depositing a nitride film on the silicon wafer.

17. The method of claim 17 wherein the nitride film has a thickness of approximately 2000 Angstoms.

18. The method of claim 17 and further comprising applying a coating of photoresist on the nitride film.

19. The method of claim 17 and further comprising removing a portion of the nitride film.

20. The method of claim 20 and further comprising removing a portion of the nitride film with potassium hydroxide etchant.

21. The method of claim 21 and further comprising applying a photoresist coating to the silicon wafer.

22. The method of claim 22 and further comprising patterning the silicon wafer with a plasma etching process.

23. The method of claim 23 and further comprising removing the photoresist coating.
